(19) United States
(12) Patent Application Publication
(10) Pub. No.: US 2011/0231713 A1
(43) Pub. Date: Sep. 22, 2011

(54) FLASH MEMORY MODULE

(75) Inventors: Masanori Takada, Yokohama (JP); Jun Kitahara, Yokohama (JP)

(73) Assignee: HITACHI, LTD., Tokyo (JP)

(21) Appl. No.: 12/664,488

(22) PCT Filed: Nov. 4, 2009
(86) PCT No.: PCT/JP2009/005859

§ 371 Date: Dec. 14, 2009

(51) Int. Cl. G06F 12/00; G06F 11/16

(52) U.S. Cl. 714/54; 711/103; 714/E11.054; 711/E12.008

(57) ABSTRACT

Logical/physical conversion information is configured from first conversion information and second conversion information. A controller of a flash memory module restores the first conversion information at boot up time, enables an access command to be received from a host after having restored the first conversion information, and restores the second conversion information after an access command is able to be received.

### TECHNICAL FIELD

The present invention generally relates to a module comprising a flash memory.

### BACKGROUND ART

Lower-cost, higher-capacity flash memory is coming into widespread use. Thanks to outstanding performance and power consumption features, flash memory use is spreading especially rapidly in modules that place emphasis on these features (for example, storage systems and compact mobile modules).

A flash memory comprises a plurality of flash memory chips (hereinafter, chips), and each chip comprises a plurality of physical blocks. A physical block is comprised from a plurality of physical pages. The physical block and the physical page are both physical storage areas. For example, the reading and writing of data are carried out in page units, and the erasing of data is carried out in block units.

The flash memory, in particular, the large-capacity NAND-type flash memory has the following two characteristic features.

The first is the fact that it is not possible to write new data over data that has already been written to a physical page, and in order to write new data to this physical page, it is necessary to carry out an erase process for the physical block comprising this physical page. Data of a fixed size is written to the erased physical block in order from the start of this block. As described above, the flash memory is limited as to the size and order of a read and a write.

The other is a wear-out phenomenon. The wear-out phenomenon is one in which the flash memory becomes unable to hold information after erase processing has been carried out more that a certain number of times. The number of erasures is more apt to reach the limit in a case where writes are carried out frequently. In a case where writes concentrate on a specific area, the physical blocks comprising this area reach the end of their service life early on.

With respect to these problems, for example, Patent Literature 1 discloses a technology in which a controller for controlling the flash memory conceals the size and order limitations of reads and writes. In accordance with Patent Literature 1, an area for appending data is disposed inside the flash memory. Also, for example, Patent Literature 2 discloses a technology for extending the service life of the flash memory by dispersing write destinations.

These technologies require information (logical/physical conversion information) for making a logical address used by a host to specify an access destination correspond to a storage-destination flash memory address (physical address). Failure to make this logical/physical conversion data nonvolatile the same as the data being written/read to/from the host will make it impossible to store the data correctly. For example, Patent Literature 3 discloses a technology for storing this logical/physical conversion information together with a user data, and restoring the original logical/physical conversion information from the stored data.

### CITATION LIST

### Patent Literature

### PTL 1

Japanese Patent Application Laid-open No. 2009-064251

### PTL 2

Japanese Patent Application Laid-open No. 2007-265265

### PTL 3

Japanese Patent Application Laid-open No. H8-077074

### SUMMARY OF INVENTION

### Technical Problem

Ordinarily, a flash memory module boots up when the power is turned ON, and restores the logical/physical conversion information at boot up time. A management information unit is required to restore the logical/physical conversion information. The management information unit, for example, is an information unit that is written into the overhead area of the physical page, and denotes which physical block comprises this physical page, and the logical page inside the logical block to which this physical page corresponds.

Although the logical/physical conversion information is able to be restored in accordance with the above-mentioned technology, all the management information units must be read in order to perform restoration. For this reason, the restoration of the logical/physical conversion information takes a long time. For example, in a case where the flash memory has a capacity of 256 GB (gigabytes) and the size of the physical page is 4 kB (kilobytes), each management information unit from 64 M (mega) (256 GB divided by 4 kB) of physical pages must be read out. Since the time required for readout is normally 100 microseconds per physical page, the restoration of the logical/physical conversion information requires around 6,400 seconds. This is an extremely long time compared to the time required to boot up a hard disk (for example, around 10 seconds). As flash memory capacity increases, the time required for booting up will most likely increase proportionally.

An object of the present invention is to reduce the time required to boot up a flash memory module.

### Solution to Problem

The logical/physical conversion information comprises a first conversion information and a second conversion information. A flash memory module controller restores the first conversion information at boot up time, making the flash memory ready to receive an access command from the host after the first conversion information has been restored, and after the flash memory is ready to receive an access command, the controller restores the second conversion information.

### Advantageous Effects of Invention

The present invention makes it possible to reduce the time required to boot up the flash memory module.

### BRIEF DESCRIPTION OF DRAWINGS

FIG. 1 shows the configuration of a flash memory module related to a first embodiment of the present invention.

FIG. 2 shows the internal configuration of a chip 5.

FIG. 3A shows the status of a physical block #p in the initialized state.

FIG. 3B shows an example of the state subsequent to new data being written to the physical block #p.

FIG. 3C shows the state of the physical block #p subsequent to a merge operation being performed.

FIG. 4 shows the configuration of a flash memory module control data 6.

FIG. 5 shows the configuration of a module control function 7.

FIG. 6 shows an example of the corresponding relationship between tables 61 and 62 inside a volatile memory 3 and the state of a physical block inside a chip array 4.

FIG. 7 shows an example of the configuration of a block mapping table 61.

FIG. 8 shows an example of the configuration of a page mapping table 62.

FIG. 9 shows an example of a scheme for storing data in a physical block 51.

FIG. 10 shows a detailed example of the configuration of a physical page 52.

FIG. 11 shows an example of the configuration of a block metadata 515.

FIG. 12 shows an example of the configuration of a page metadata 526.

FIG. 13 shows an example of the flow of processing carried out by a host read service function 71.

FIG. 14 shows an example of the flow of processing carried out by a host write service function 72.

FIG. 15 shows an example of the flow of processing carried out by a page mapping table reconstruct function 74.

FIG. 16 shows an example of the flow of processing carried out by a power ON function 75.

FIG. 17 shows an example of the flow of processing carried out by an initialize function 76.

FIG. 18 shows an example of an exchange between a controller 2 and the chip array 4 in S726 of the host write service function 72.

FIG. 19 shows an example of the exchanges between the controller 2 and the chip array 4 in S728 through S730 of the host write service function.

FIG. 20 shows an example of the exchanges between the controller 2 and the chip array 4 in S752 of the power ON function 75 and in S743 of the page mapping table reconstruct function 74.

FIG. 21 shows an example of the corresponding relationship between a logical address and a logical block/logical page in the first embodiment of the present invention.

### DESCRIPTION OF EMBODIMENTS

A flash memory module in which a flash memory module related to the first embodiment of the present invention is used will be explained below by referring to the attached drawings. However, it should be noted that this embodiment is merely an example for realizing the present invention, and does not limit the technical scope of the present invention. Also, the same reference signs will be assigned to common configurations in the respective drawings.

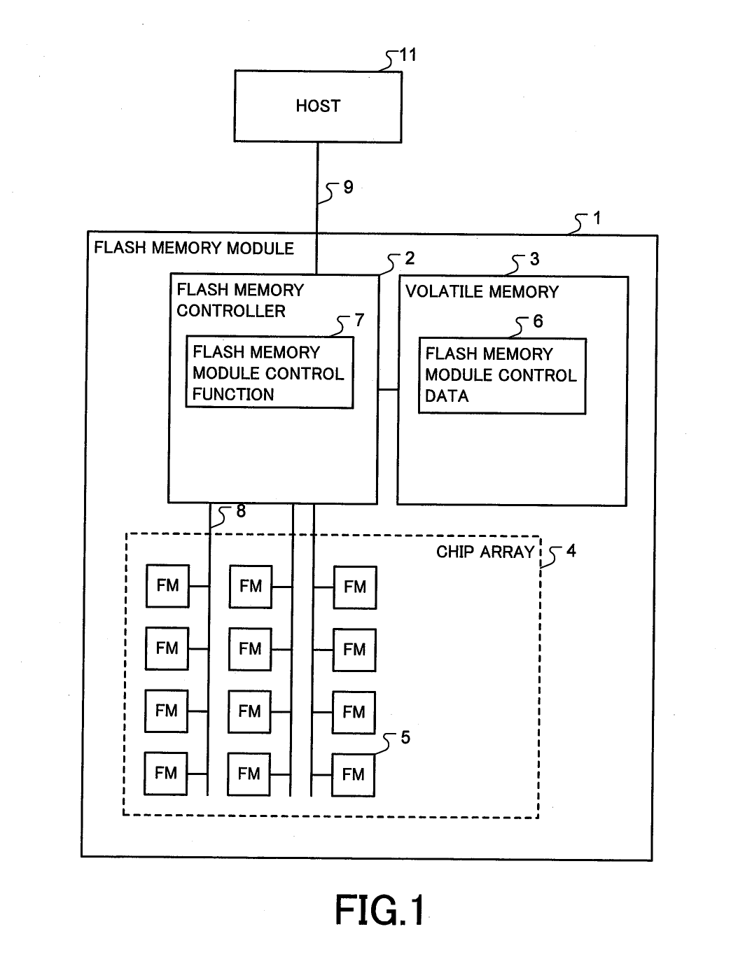

FIG. 1 shows the configuration of a flash memory module related to the first embodiment of the present invention.

The flash memory module 1 comprises a flash memory controller (hereinafter, controller) 2, a volatile memory 3, a chip array (one or more flash memories) 4, a flash memory bus 8, and a host interface 9. The flash memory module 1, for example, may be the same shape as a 3.5-inch or 2.5-inch hard disk drive, or may be larger or smaller than same.

The chip array 4 comprises a plurality of flash memory chips (hereinafter, chip) 5.

The controller 2 controls the chip array 4, and also controls communications with a host 11. For example, the controller 2 comprises a processor for executing a flash memory control software (a computer program), a memory controller for writing/reading data to/from the chip 5, and a host interface controller for exchanging data with the host 11. In FIG. 1, the controller 2 comprises a single LSI (Large Scale Integration), but, for example, the controller 2 may also be comprised of a plurality of IC (Integrated Circuit) chips, such as an externally connected processor. The flash memory module control function (hereinafter, module control function) 7 of the controller 2 will be explained below.

The volatile memory 3 is used for storing, from among the information handled by the controller 2, the information required for rapid access. Specifically, for example, the volatile memory 3 stores the above-mentioned flash memory control software, and a flash memory module control data (hereinafter, module control data) 6 used by this software. A detailed explanation of the module control data 6 will be given below. The volatile memory 3, for example, is a DRAM (Dynamic Random Access Memory). Furthermore, another type of storage medium may be used instead of a volatile memory 3 as long as it is capable of high-speed access.

The chip 5 is used for storing information written/read to/from the host 11. Data that should be nonvolatile is also stored from among the information required for control. This will be explained in detail below.

The flash memory bus 8 is used for connecting the controller 2 and the chip 5. In FIG. 1, a plurality of chips 5 are connected to one flash memory bus 8, but another connection scheme may be used.

The host interface 9 is used to connect the flash memory module 1 to the host 11, and to carry out the exchange of information. For example, a SATA (Serial ATA), SAS (Serial Attached SCSI), FC (Fibre Channel) or other such storage interface may be used as the host interface 9, and a PCI-Express or other such I/O-type interface may also be used.

The flash memory module 1 may be provided in the storage system. In this case, the storage system comprises a plurality of flash memory modules 1. A RAID group is comprised of two or more memory modules 1. A logical volume is created based on the RAID group. In accordance with this, the host 11 may be a controller (hereinafter, storage controller) of the storage system, or may be a host computer that is connected to the storage system. In the case of the former, the storage controller is able to send an access-destination logical address that accords with an I/O command from the host computer to the flash memory module 1 that manages this logical address, and to access the physical block that corresponds to this logical address.

Further, the flash memory module 1 may be a SSD (Solid State Drive) or a portable flash memory module. In this case, the host 11 may be a computer.

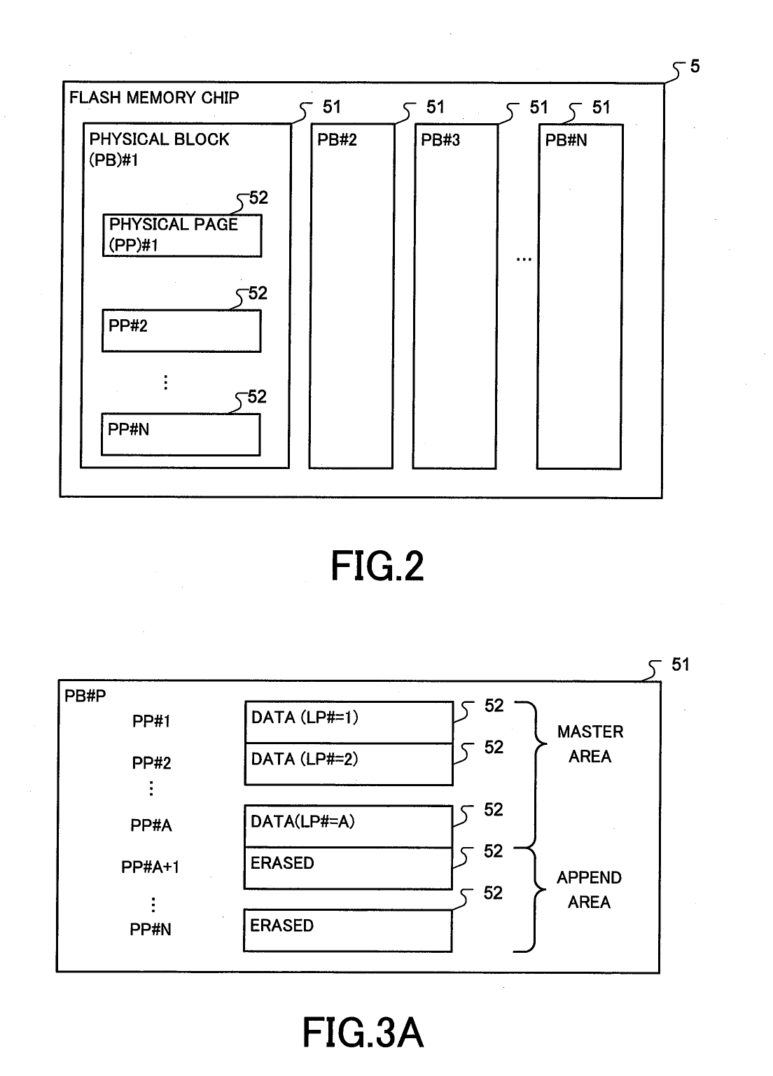

FIG. 2 shows the internal configuration of a chip 5. Furthermore, in FIG. 2 and the subsequent drawings, the physical block is abbreviated as “PB”, the physical page is abbreviated as “PP”, the logical block is abbreviated as “LB” and the logical page is abbreviated as “LP”.

The chip 5 is comprised of a plurality of physical blocks 51. The physical block 51 is comprised of a plurality of physical pages 52.

The chip 5 has three interfaces, read, write and erase. Specifically, these are as follows.

(Read) It is possible to read in data from either an entire physical page 52, or a portion of a physical page 52.

(Write) It is possible to write data to an empty physical page (a physical page, which has been erased, and on which nothing is written) 52 in order from the start of the physical block 51. Specifically, for example, for physical block 51, in which data is only written on physical page #1, a write is possible to physical page #2, but it is not possible to overwrite the data in physical page #1. It is also not possible to skip physical page #2 and write data to physical page #3.

(Erase) It is possible to erase data in physical block 51 units. That is, it is not possible to erase only one part inside the physical block 51, and make that part an unwritten state (that is, make it an empty block).

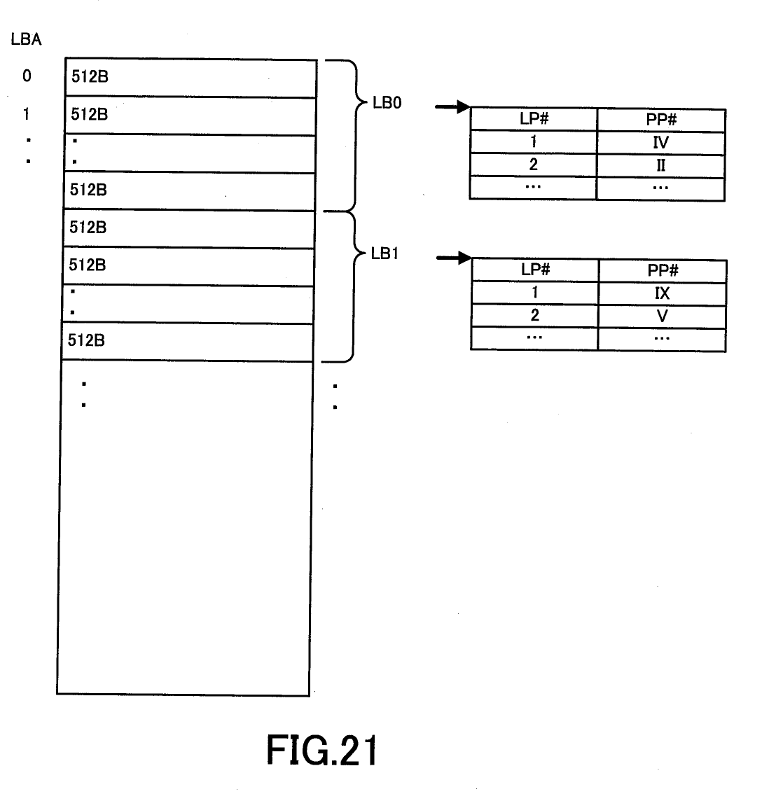

Normally, the size of the physical block, the size of the physical page, and the size of the read/write unit from the host 11 will differ. For example, as shown in FIG. 21, the physical block is 256 kB, the physical page is 2 kB, and the size of the unit being written/read to/from the host 11 (the access size) is 512 B. That is, a logical block is allocated for each range of logical addresses capable of being specified from the host 11, and a physical block is allocated to the logical block. One or more physical blocks may be allocated to one logical block, but in this embodiment, it is supposed that one physical block is allocated to one logical block. The physical block is configured from a plurality of physical pages. A physical page inside a physical block allocated to a logical block is allocated to each logical page configuring the logical block. The controller 2 is able to specify the logical page of the access destination by performing a predetermined operation based on the logical address specified in the access command from the host 11, and is able to specify the physical page corresponding to the access-destination logical page based on the module control data 6.

For this reason, a mechanism for making up the difference between the size of the access from the host 11 and the size of the write unit/erase unit (page/block) of the chip 5 is needed for a write.

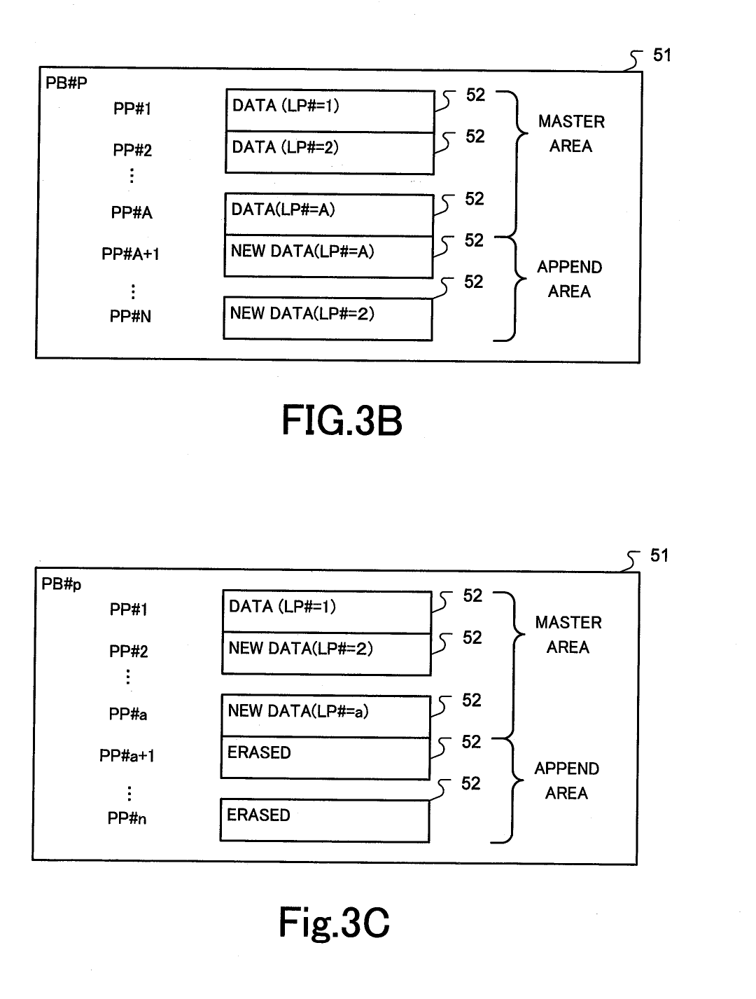

FIGS. 3A through 3C show examples of the controller 2 operations for concealing the difference between the chip 5 page/block size and the size of the access from the host 11. Furthermore, in FIGS. 3A through 3C, a physical block 51 having p as the physical block number (PB#) is given as an example, but the configuration is the same for another physical block 51 as well. The physical block 51 with PB# of p will be referred to as “physical block #p” below.

A plurality of physical pages 52 inside the physical block #p are divided into a master area and an append area. That is, there are physical pages 52 that belong to the master area and physical pages 52 that belong to the append area in the physical block #p. The data written to each physical page 52 is managed using a logical page number (LP#).

FIG. 3A shows the status of the physical block #p in the initialized state.

In the initialized state, the data from a logical page #1 (the logical page having 1 as the LP#) to a logical page #a are respectively written to each physical page 52 from a physical page #1 (the physical page having 1 as the PP#) to a physical page #a. For the remaining physical pages 52 (that is, from physical page #(a+1) through physical page #n), the state (erased state) is one in which data has yet to be written in.

FIG. 3B shows an example of the state subsequent to new data having been written to the physical block #p.

In this example, the data to be written to logical page #a is stored in the physical page #(a+1), and the data to be written to logical page #2 is stored in physical page #n. In so doing, it becomes possible to append data to the physical block #p without erasing the physical block #p (strictly speaking, without performing an erase process for the physical block #p) with respect to a write unit request that is smaller than the size of the physical block #p.

However, according to the example of FIG. 3B, since data is written up to the last physical page #n in the append area, a physical page that is capable of being written to does not exist in the physical block #p. Accordingly, the controller 2 carries out a merge operation (reclamation) that reflects the appended data in the master area. In the merge operation, the controller 2 reads in the latest data of each logical page from the physical block #p, and after carrying out an erase process for the physical block #p, writes the latest data for the logical page corresponding to this physical page in order from the first physical page of the master area. Furthermore, so that the data write is carried out in order from the first physical page to the last physical page, the latest data corresponding to the same logical page exists in either the last physical page or the physical page closest to the last physical page.

FIG. 3C shows the state of the physical block #p after the merge operation has been carried out.

The data is written in order from the first physical page of the master area, and all the physical pages comprising the append area are in an erased state. The first physical page #1 through the last physical page #a of the master area correspond to the logical pages #1 through #a. Therefore, for example, the data (the latest data) written in the physical page #1 prior to the merge operation is once again written to physical page #1. This is because the data of the logical page #1 has not been updated. The latest data of the logical page #2 (the data written to the append area) is written to the physical page #2.

Furthermore, the data write destination in the merge operation may be another empty block (an erased physical block) instead of the same physical block #p. Specifically, for example, the respective latest data corresponding to the respective logical pages inside the physical block #p may be copied to an empty block, and thereafter, an erase process may be carried out with respect to the physical block #p.

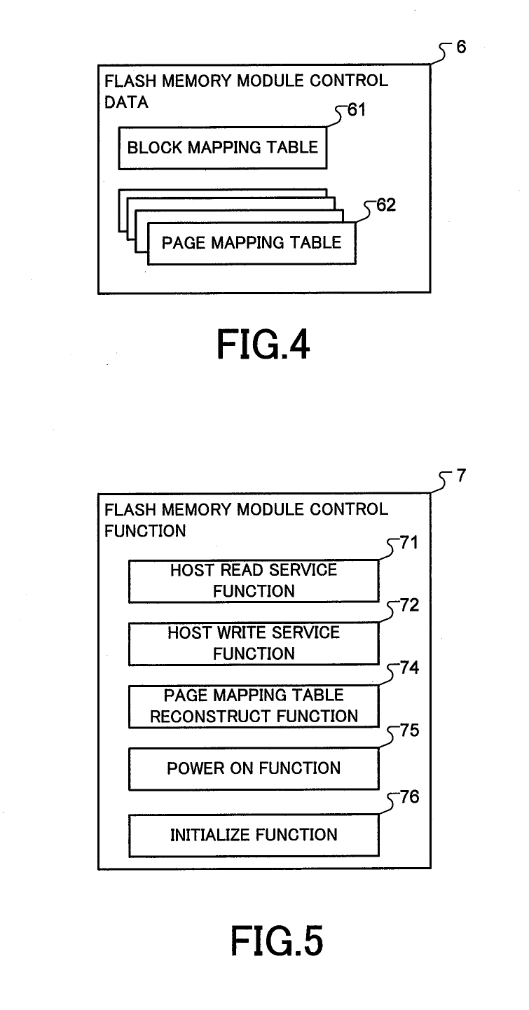

FIG. 4 shows the configuration of the module control data 6.

The module control data 6 is data used in controlling access to the chip array 4. The module control data 6 comprises a block mapping table 61 comprising information denoting the corresponding relationship between the logical blocks and the physical blocks, and a page mapping table 62 comprising information denoting the corresponding relationship between the logical pages and the physical pages. These tables 61 and 62 will be explained in detail below. Furthermore, the information of the tables 61 and 62 may be managed in a form other than a table.

FIG. 5 shows the configuration of the module control function 7.

The module control function 7, for example, is a software (a computer program) that is executed by the processor (a typical microprocessor) of the controller 2. The process carried out by the module control function 7 below is actually performed by the processor that executes this software. At least one part of the module control function 7 may be realized using a hardware circuit. The module control function 7 comprises the host read service function 71, the host write service function 72, the page mapping table reconstruct function 74, the power ON function 75, and the initialize function 76. The functions 71 through 76 will be explained in detail below.

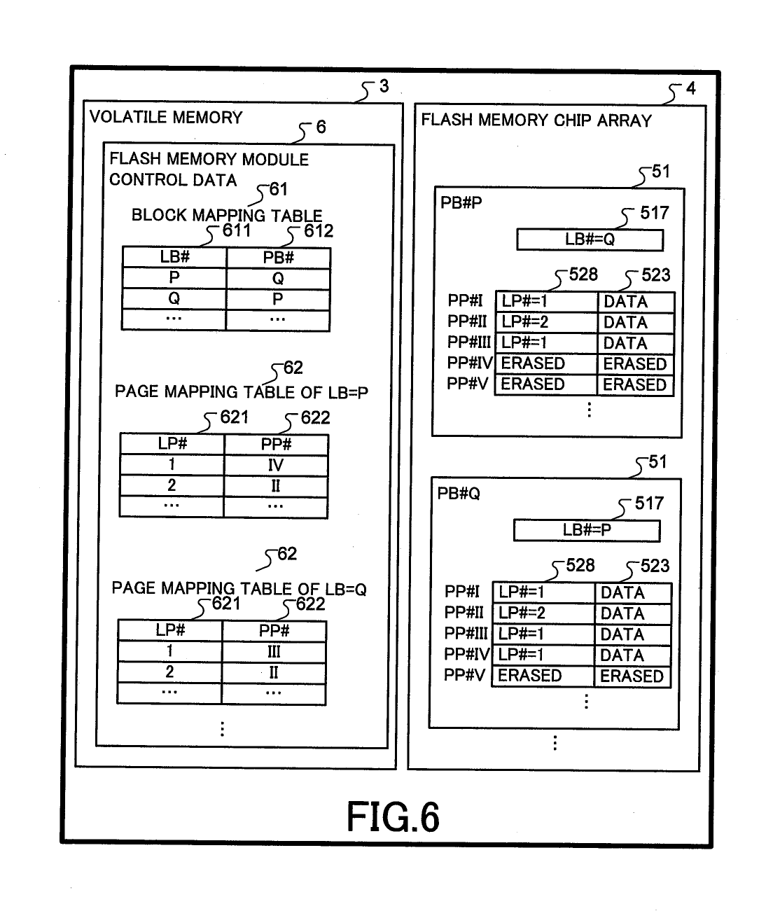

FIG. 6 shows an example of the corresponding relationship between the tables 61 and 62 inside the volatile memory 3 and the state of the physical block inside the chip array 4.

In this embodiment, the logical block number and the logical page number are specified based on the logical address specified by the host 11, and access is carried out to the physical page corresponding to the specified logical block number and logical page number. Specifically, for example, in a case where an access from the host 11 to the flash memory module 1 is carried out using a LBA (Logical Block Address) in SCSI, the quotient obtained by dividing the LBA by the capacity of the master area inside the block is the logical block number, and the quotient obtained by dividing the remainder by the page capacity is the logical page number.

The block mapping table 61 comprises information denoting the corresponding relationship between each logical block number 611 and each physical block number 612. By referring to this table 61, it is possible to determine the physical block 51 in which the access-destination area corresponding to the logical address specified by the host 11 exists.

The page mapping table 62, for example, exists in each logical block. The page mapping table 62 comprises information denoting the corresponding relationship between each logical page number 621 and each physical page number 622. By referring to this table 62, it is possible to determine the physical page in which the access-destination area corresponding to the logical address specified by the host 11 exists.

The physical block 51 stores the logical block number 517 of the logical block to which this physical block 51 is allocated. The physical page 52 (for example, this user area) stores data (so-called user data) 523 that is written/read directly to/from the host 11. This physical page 52 (for example, this overhead area) also stores the logical page number 528 corresponding to this physical page 52.

Specifically, for example, in the overhead area of each physical page 52 there is stored metadata comprising the logical page number 528 corresponding to this physical page 52. As used in this embodiment, “metadata” is not the data written/read directly to/from the host 11, but rather refers to the data required for management purposes. Metadata, for example, is the management information unit.

For example, in addition to the logical page number 528 corresponding to the first physical page #i, the metadata stored in the overhead area of the first physical page #i may also include the logical block number 517 of the logical block to which is allocated the physical block 51 having this first physical page #i.

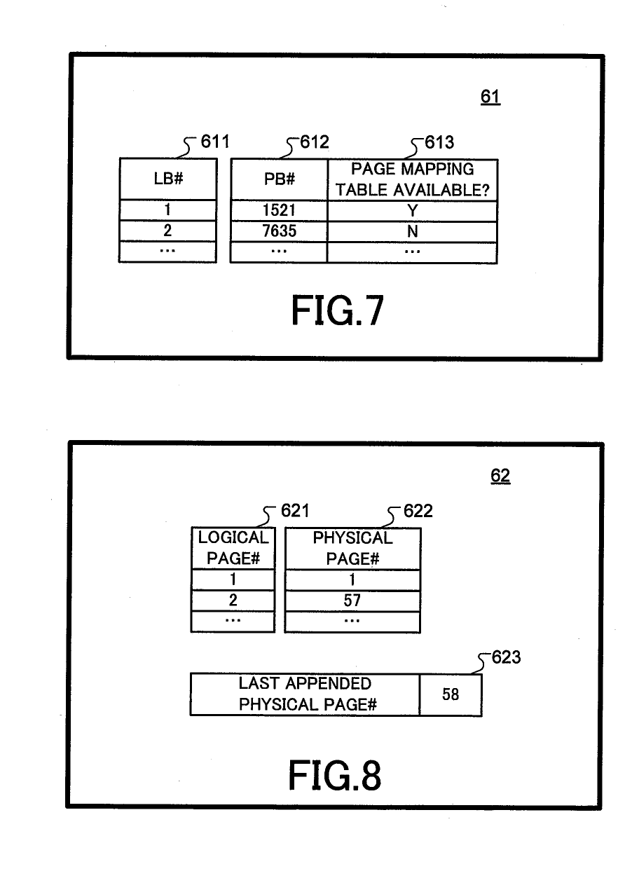

FIG. 7 shows an example of the configuration of the block mapping table 61.

This table 61 comprises information denoting the corresponding relationship (the block corresponding relationship) between the logical block numbers 611 and the physical block numbers 612. This table 61 is created when the power to the flash memory module 1 is turned ON, and is referred to at the time of a write/read to/from the host 11. This table 61 is updated in a case where the block corresponding relationship has changed. The block corresponding relationship, for example, changes in a case where wear-leveling for suppressing the bias of the number of erasures is carried out. The block corresponding relationship may also change in a case where a merge operation is performed for any physical block 51, and in a case where the page mapping table 62 has been reconstructed.

For each logical block number 611, the block mapping table 61 comprises a corresponding physical block number 612, and a page mapping table flag 613 showing whether or not a page mapping table 62 is available. In a case where a valid page mapping table 62 is available for a logical block, the value of the flag 613 corresponding to this logical block number 611 is “Y”, and in a case where a valid page mapping table 62 is not available for a logical block, the value of the flag 613 is “N”. Furthermore, the value of the flag 613, for example, is changed from “Y” to “N” in a case where the physical block allocated to the corresponding logical block has changed to a different physical block (that is, in a case where the merge operation has been carried out). For this reason, in a case where this logical block is to be accessed for the first time since this different physical block has been allocated to the corresponding logical block, the page mapping table 62 for this logical block is reconstructed.

FIG. 8 shows an example of the configuration of the page mapping table 62.

This table 62 comprises information denoting the corresponding relationship (page corresponding relationship) between the logical page numbers 621 and the physical page numbers 622. The above-mentioned block mapping table 61 is created when the power to the flash memory module 1 is turned ON, but this table 62 is not created when the power to the flash memory module 1 is turned ON, but rather is created in a case where a logical block specified based on a logical address is the access destination for the first time subsequent to the power to the flash memory module 1 having been turned ON. The table 62 is referred to at the time of a data write/read to/from the host 11, and is updated at the time of a merge operation or a data write from the host 11. The table 62 comprises a corresponding physical page number 612 for each logical page number 611. The table 62 also comprises the number (last appended physical page number) 623 of the physical page to which data was last appended of the plurality of physical pages comprising the append area.

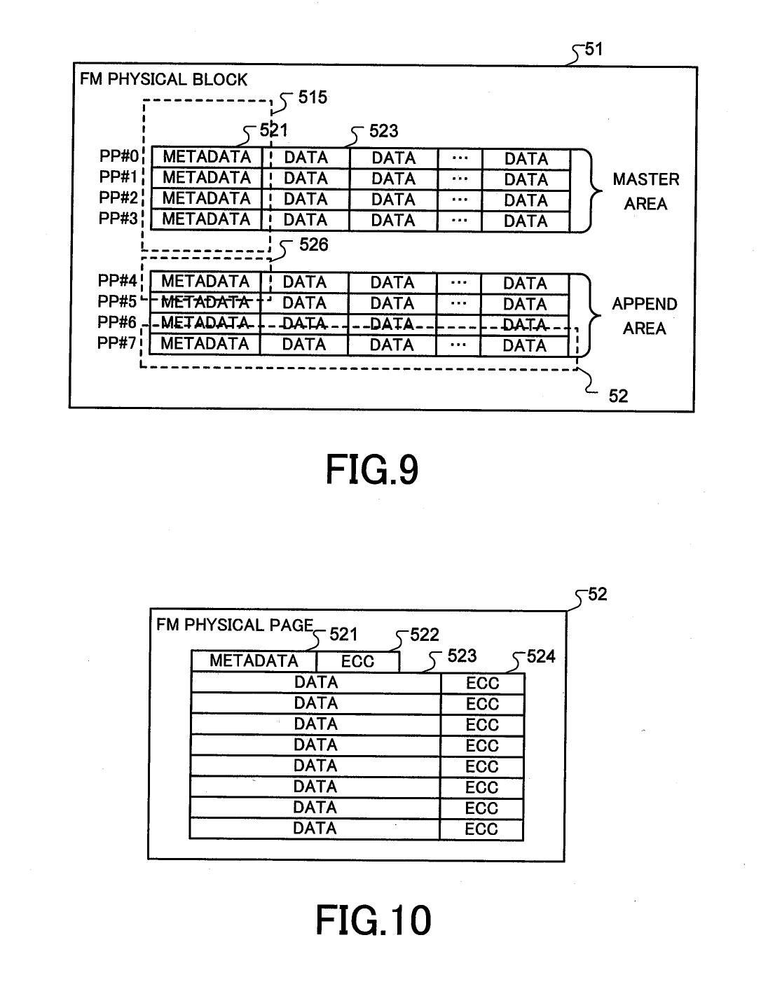

FIG. 9 shows an example of a scheme for storing data in the physical block 51.

As described above, the plurality of physical pages 52 included in the physical block 51 are physical pages 52 belonging to the master area and physical pages 52 belonging to the append area. Each physical page 52 comprises an area (overhead area) in which metadata 521 is stored, and a user area, and the user area comprises a plurality of data areas (for example, sectors) 523 in which are stored a plurality of data 523.

A set of metadata inside the master area, that is, a set of metadata 521 of the physical page 52 belonging to the master area will be called “block metadata” 515 below. By contrast, the individual pieces of metadata 521 inside the append area, that is, the metadata 521 of the physical page 52 belonging to the append area will be called the “page metadata” 526. Incidentally, in a case where the total capacity of the metadata areas inside the master area is greater than the capacity of the block metadata 515 to be stored, at least one physical page 52 inside the master area may not be used to store the block metadata 515.

FIG. 10 shows a detailed example of the configuration of the physical page 52.

The physical page 52 comprises a metadata area in which the metadata 521 is stored, an ECC (Error Correcting Code) area in which the ECC 522 of this metadata 521 is stored, a plurality of data areas in which the plurality of data 523 are respectively stored, and an ECC area in which the ECC 524 of these respective data are stored.

As shown in FIG. 9, the metadata area stores a portion of the block metadata 515 in a case where the physical page 52 comprising this area belongs to the master area, and stores the page metadata 526 in a case where this physical page 52 belongs to the append area.

By providing the ECC 522 for the metadata 521 (specifically, the portion of the block metadata 515 and the page metadata 526), it is possible to determine the validity (that is, whether or not an error has occurred) of the metadata 521 even in a case where only the metadata 521 has been read in.

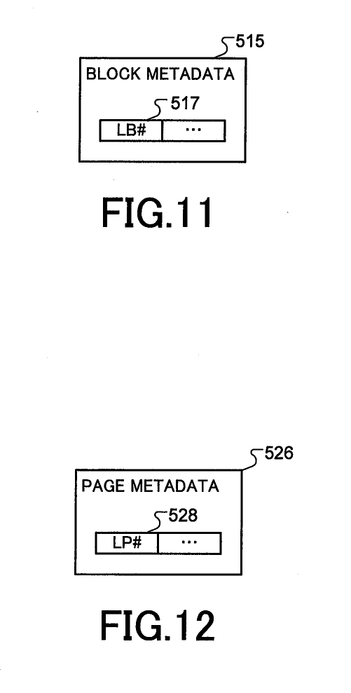

FIG. 11 shows an example of the configuration of the block metadata 515.

The block metadata 515 comprises the number 517 of the logical block corresponding to the physical block 51.

FIG. 12 shows an example of the configuration of the page metadata 526.

The page metadata 526 comprises the number 528 of the logical page corresponding to the physical page 52 inside the append area. Since the number of the logical page corresponding to the physical page 52 inside the master area is uniquely stipulated, the corresponding logical page 528 need not be stored in the metadata area inside the master area.

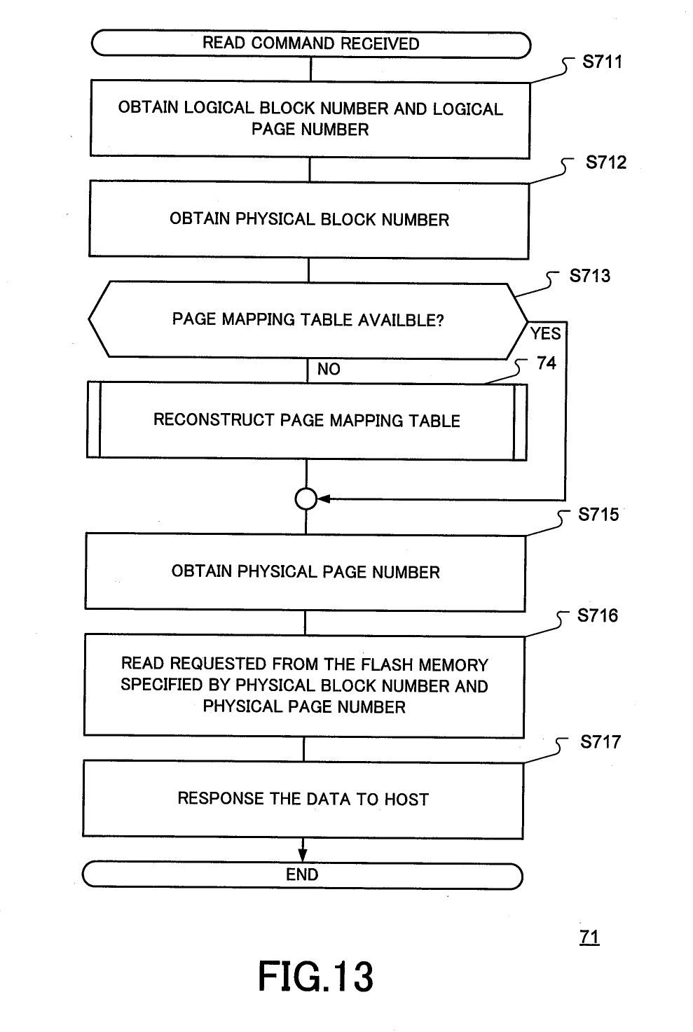

FIG. 13 shows an example of the flow of processing carried out by the host read service function 71.

This function 71 is called when the controller 2 has received a read request from the host 11, specifies a location on the chip array 4 in which the specified data is stored, and transfers the data to the host 11. The details of this process will be explained on a step-by-step basis below.

Upon receiving a read request from the host 11, the function 71 determines the logical block number and the logical page number (S711). Specifically, for example, in a case where the logical address specified from the host 11 is an LBA or other linear address, the function 71 is able to let the quotient obtained by dividing the logical address by the logical block capacity be the logical block number, and is able to let the quotient obtained by dividing the remainder by the logical page capacity be the logical page number. The logical block number and the logical page number specified in S711 will be called the “read-source logical block number” and the “read-source logical page number” below.

Next, the function 71 refers to the block mapping table 61 on the volatile memory 3, and determines the physical block number (the read-source physical block number) 612 corresponding to the read-source logical block number 611 (S712).

Next, the function 71 checks whether or not a valid page mapping table 62 corresponding to the read-source logical block is available on the volatile memory 3 (S713). Specifically, for example, the function 71 refers to the block mapping table 61, and checks whether or not the flag 613 corresponding to the read-source logical block number is “Y”. In a case where a valid page mapping table 62 is not available (S713: NO), the function 71 calls the reconstruct function 74. In accordance with this, a valid page mapping table 62 corresponding to the read-source logical block is constructed. Then, the function 71 proceeds to S715. Furthermore, in a case where a valid page mapping table 62 is available in S713 (S713: YES), the function 71 proceeds to S715.

The function 71 refers to the page mapping table 62 corresponding to the read-source logical block, and determines the physical page number (the read-source physical page number) 622 corresponding to the read-source logical page number 621 (S715). In accordance with the above, the read-source physical block and the read-source physical page of the data requested by the host 11 are identified.

Next, the function 71 reads the data from the identified read-source physical page inside the identified read-source physical block (S716), and responds to the host 11 with the read data (S717).

In accordance with the above processing, in a case where a read request has been received from the host 11, first, the read-source physical block 51, which is the general storage location, is specified as an access destination, and thereafter, a page mapping table 62 denoting the corresponding relationship between the logical pages and the physical pages is constructed as necessary, and the read-source physical page 52 is specified. For this reason, the information denoting the detailed logical/physical corresponding relationship, that is, the table 62 denoting the corresponding relationship between the logical pages and the physical pages does not need to be created in advance. The block mapping table 61 and the page mapping table 62 are stored on volatile memory 3. The time required to access these tables is shorter than the time required to access the flash memory, thereby making it possible to hold read performance degradation in check.

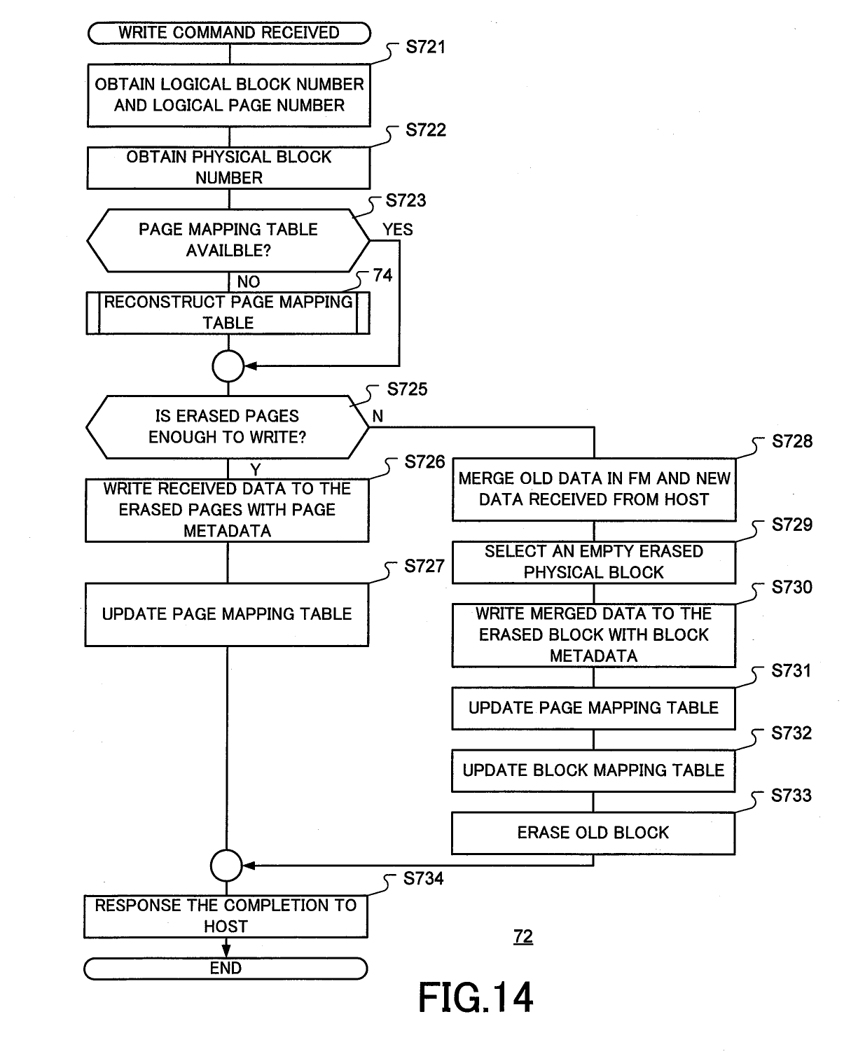

FIG. 14 shows an example of the flow of processing carried out by the host write service function 72.

This function 72 is called when a write request has been received from the host 11, and stores the requested data in a suitable location. The details of this process will be explained on a step-by-step basis below.

Upon receiving a write request from the host 11, the function 72 determines the logical block number (the write-destination logical block number) and the logical page number (the write-destination logical page number) based on the logical address specified in the write request (S721).

Next, the function 72 refers to the block mapping table 61, and determines the physical block number (the write-destination physical block number) corresponding to the write-destination logical block number (S722).

Then, the function 72 refers to the flag 613 corresponding to the write-destination logical block number, and checks whether or not a valid page mapping table 62 corresponding to this logical block number is available (S723). In a case where this table 62 is not available (S723: NO), the function 72 calls the reconstruct function 74. In accordance with this, a page mapping table 62 corresponding to the write-destination logical block is created. Then, the function 72 proceeds to S725.

The function 72 checks whether or not there are enough erased pages (empty physical pages) in the write-destination physical block (S725). Specifically, for example, the function 72 refers to the last appended physical page number 623 of the page mapping table 62 corresponding to the write-destination logical page. Then, the function 72 checks the number of empty physical pages inside the write-destination physical block by comparing this page number 623 against the maximum value of the physical page number (the number of the last physical page). The function 72 determines whether or not the amount of data (write data) that accords with the write request from the host 11 exceeds a capacity equivalent to the specified number of empty physical pages.

In a case where the result of the determination of S725 is affirmative, that is, in a case where there are enough erased pages (S725: YES), the function 72 writes the write data received from the host 11 to the page metadata 526 and to the erased pages (S726). The logical page number determined in S721 is included in the page metadata 526. The function 72, either in S732 or between 74 and S725, determines whether or not the data is stored in the physical page of the same number as the write-destination logical page number (that is, the corresponding physical page inside the master area), and in a case where the data is determined to be stored in this physical page, the function 72 may carry out the determination of S725. In a case where the data is determined not to be stored in this physical page, the function 72 is able to write the write data received from the host 11 to the physical page of the same number as the write-destination logical page number. In the case of a first write to the write-destination physical block, the function 72 may write the write data and the block metadata 515 to this physical block.

Subsequent to S726, the function 72 updates the page mapping table 62 corresponding to the write-destination logical block (S727). Specifically, for example, the function 72 updates the physical page number 622 of the entry (the entry inside the table 62) comprising the write-destination logical page number to the number of the write-destination physical page in S726, and, in addition, updates the last appended physical page number 623 to the number of the last write-destination physical page in S726. Then the function 72 proceeds to S734.

By contrast, in a case where there are not enough erased pages in S725 (S725: NO), the merge operation is performed. That is, the function 72 reads in the data (the latest data of the one or more pieces of data corresponding to the logical page) that exists in the write-destination physical block (hereinafter, the old physical block), merges this data with the write data received from the host 11, and creates a set of data to be written to the master area (S728). Next, the function 72 selects one unused physical block (empty physical block) (S729). In this case, the function 72 may adopt a method of selecting a physical block which is not subjected to erasure so often in order to suppress the bias of the number of erasures among the physical blocks on the chip array 4. Then, the function 72 writes the data created in S728 to the selected physical block as well as to the block metadata 515 (S730). This block metadata 515 comprises the number of the logical block (write-destination logical block number) to which the old physical block is allocated. Then, the function 72 updates the page mapping table 62 corresponding to the write-destination logical block (S731). Specifically, for example, the function 72 performs updating such that the physical pages 622 corresponding to all the logical pages 621 point to the master area, and, in addition, updates the last appended physical page number 623 to the number of the first physical page of the append area. Next, the function 72 updates the block mapping table 61 (S732). Specifically, for example, the function 72 performs updating such that the physical block number 612 corresponding to the write-destination logical block number 611 points to the number of the new physical block written to in S730 (the physical block selected in S729). Next, the function 72 erases the data of the old physical block 51 (S733). Then, the function 72 proceeds to S734.

Lastly, the function 72 responds to the host 11 to the effect that the write has been completed (S734).

According to the above processing, in a case where a write request has been received from the host 11, the controller 2 is able to specify the write-destination physical block 51, which is the general storage location. Then, as necessary, the controller 2 is able to create a mapping table 62 denoting the corresponding relationship between the logical pages and the physical pages, and is able to store the data in a suitable location. In both a case where the corresponding relationship between the logical blocks and the physical blocks changes, and a case where the corresponding relationship between the logical pages and the physical pages changes, the controller 2, in addition to writing the write data to the flash memory, is also able to write as metadata information showing which is the write-destination logical block and which is the write-destination logical page. It is therefore possible to write the information for logical/physical conversion to the flash memory without generating excessive accesses. For this reason, it is possible to restore the block mapping table 61 and the page mapping table 62 from the metadata (the block metadata and the page metadata) written in the flash memory even when the volatile memory 3 has been erased due to a loss of power, and the block mapping table 61 and the page mapping table 62 have been erased. For example, restoration may be carried out only for the block mapping table 61, and thereafter, the page mapping table 62 may be restored as needed in accordance with a write access and a read access.

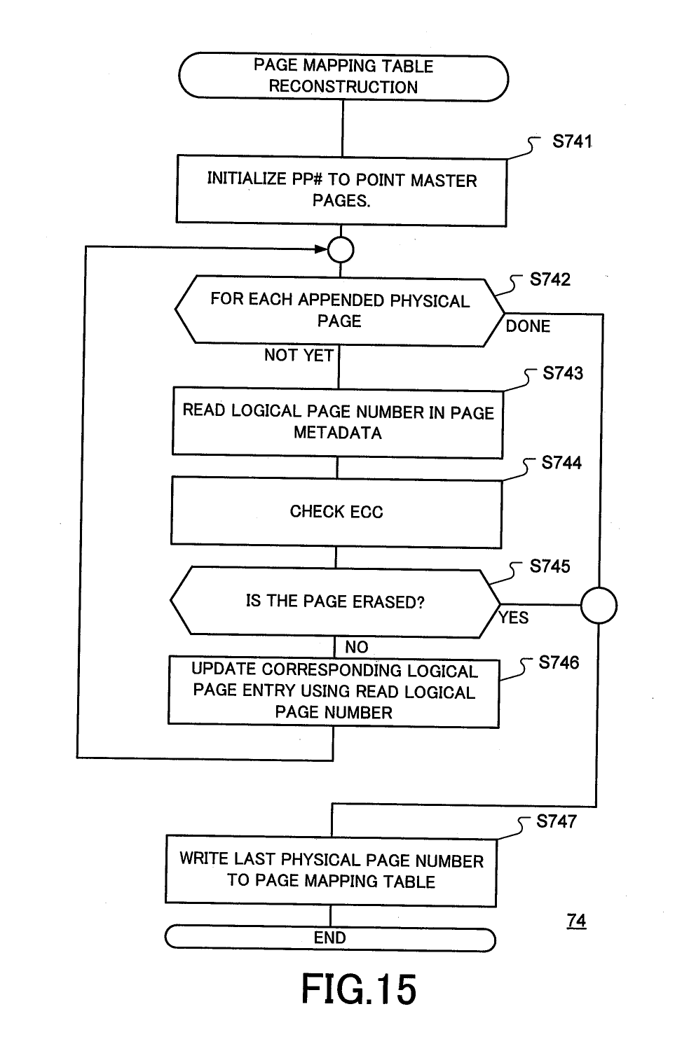

FIG. 15 shows an example of the flow of processing carried out in accordance with page mapping table reconstruct function 74.

This function 74 is called in a case where a page mapping table 62 corresponding to the logical block is not available on the volatile memory 3, and creates a page mapping table 62 based on the page metadata 526 on the flash memory. The details of the process will be explained on a step-by-step basis below.

Upon being called, the function 74 first performs initialization such that the logical page points to the physical page 52 of the master area in a page mapping table 62 corresponding to the called logical block (either the read-source logical block or the write-destination logical block) (S741). Specifically, for example, the function 74 performs the same processing for subsequent logical pages so that the first logical page points to the first physical page, and the second logical page points to the second physical page.

Next, the function 74 first reads in the page metadata 526 for all the physical pages 52 inside the append area (S742), and acquires the logical, page number 528 inside this metadata 526 (S743). The function 74 also confirms that the read-in page metadata 526 is correct (confirms the presence or absence of an error in the metadata 526) by checking the ECC for the read-in page metadata 526 (S744). In a case where this metadata 526 is not correct, the ECC is used to correct this metadata 526. In a case where the data read-source physical page was the page that got erased, the function 74 proceeds to S747 since the page metadata has already been read from all the physical pages inside the append area. In a case where the data read-source physical page was not the page that got erased, appended data exists in this physical page, and the function 74 writes the number of this read-source physical page as the physical page number 622 corresponding to the logical page number specified in S743 for the entry (the entry inside the page mapping table 62) comprising the logical page number specified in S743 (S746). The function 74 repeats the above processing for the other physical pages 52 of the append area (S742), and proceeds to S747 when this processing is finished.

Lastly, upon finishing the updating of the physical page number 622 of the page mapping table 62, the function 74 updates the last appended physical page number 623 to the number of the last physical page to which the latest data has been written (S747).

According to the above steps, in a case where there is appended data, the physical page in which the latest data has been appended is associated with each logical page inside a certain specified logical block, and in a case where there is no appended data, the physical page of the master area is associated with each logical page inside the certain specified logical block. As result of this, it is possible to reconstruct (create) a page logical/physical corresponding relationship for one block. Since only the page metadata 526 of the append area may be read in this process, it is possible to minimize the restoration overhead.

Furthermore, as has already been explained, the function 74 is called by the host read service function 71 and the host write service function 72 in the case of an access to a logical block for which a page mapping table 62 has not been created. However, when the controller 2 has excess throughput, the processing shown in FIG. 15 may be executed at a suitable time even without a request.

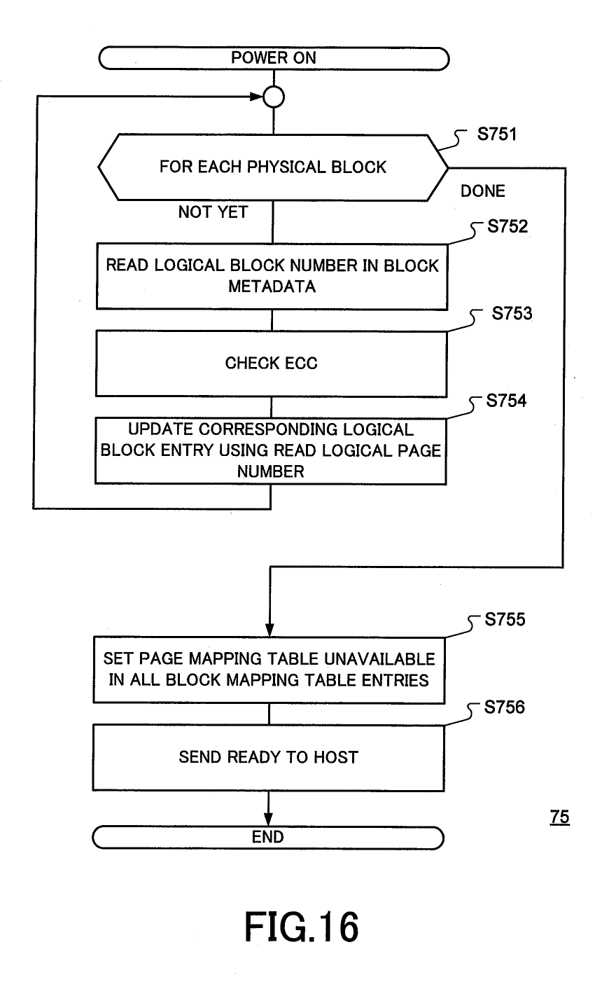

FIG. 16 shows an example of the flow of processing carried out by the power ON function 75.

This function 75 is called when the power to the flash memory module 1 is turned ON, and creates the block mapping table 61 on the basis of the metadata on the flash memory. The details of this process will be explained on a step-by-step basis below.

When the power is turned ON, first, the function 75 carries out the processing of S752 through S754 for all of the physical blocks 51. That is, the function 75 reads out the block metadata 515 from each physical block 51, and extracts the logical block number 517 from this metadata 515 (S752). Next, the function 75 checks to make sure this metadata 515 is correct by checking the ECC for the read-in block metadata 515 (S753). Then, in the block mapping table 61, the function 75 writes the read-source physical block number 612 of the metadata 515 into the entry corresponding to the logical block number 611 read in S752 (S754). The function 75 repeats the above processing for the other physical blocks 51 (S751), and proceeds to S755 when the processing is finished.

Next, the function 75 sets the page mapping table flags 613 of all the entries in the block mapping table 61 to “N”, that is, to the value denoting unavailable (S755)

Lastly, the function 75 conveys to the host 11 the fact that the flash memory module 1 is ready to receive I/O (S756).

According to the above steps, the physical blocks corresponding to all the logical blocks inside the flash memory module 1 are identified. As a result, the block logical/physical corresponding relationship may be restored on the basis of information stored in the flash memory. Furthermore, in this process, since it is all right to read only the block metadata 515 stored in the master area, there is no need to read out the data received from the host 11 and the page metadata 526. It is therefore possible to minimize restoration overhead. As a result of this, it is possible to reduce the time required for boot up, thereby making it possible to convey to the host 11 in a short period of time that fact that I/O are ready to be received.

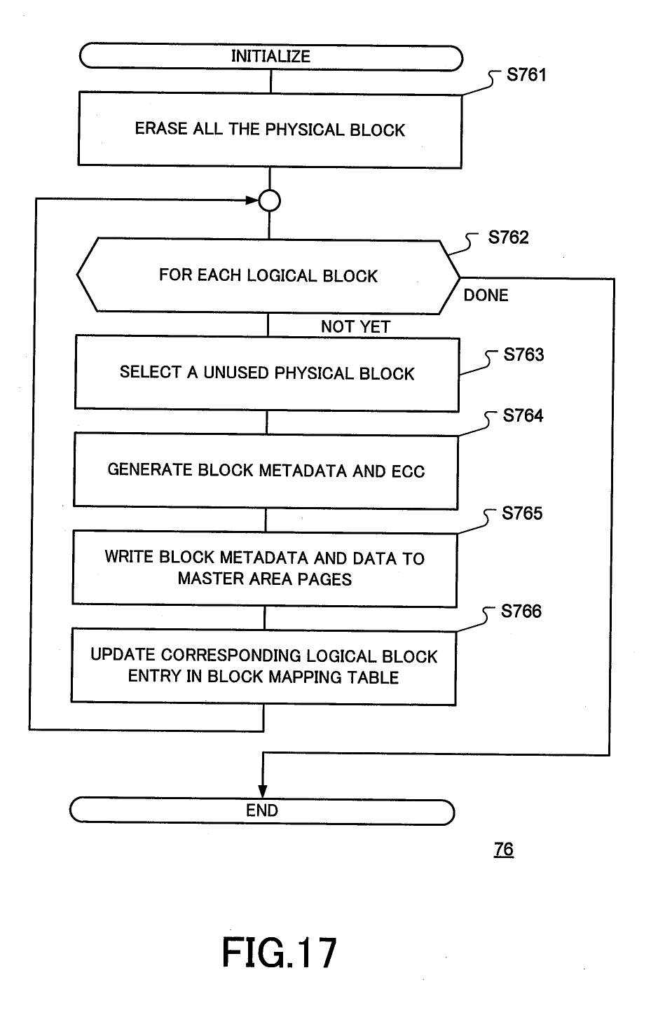

FIG. 17 shows an example of the flow of processing carried out by the initialize function 76.

This function 76 is used when the flash memory module 1 is used for the first time, and when erasing already stored data to return to the unused state once again. The details of this process will be explained on a step-by-step basis below.

Upon being called, the function 76 first carries out an erase process for all the physical blocks 51 (S761).

The function 76 selects an unused physical block (an empty physical block) 51 for a single logical block from among the unprocessed logical blocks (S763).

Next, the function 76 creates the block metadata 515 and the ECC thereof (S764). The number of the above-mentioned single logical block being used in this process is stored in the block metadata 515.

Next, the function 76 stores the created block metadata 515 and data in the physical pages 52 of the master area (S765). The “data” referred to here may be a fixed value such as that utilized in an HDD format or the like.

Finally, the function 76 updates the physical block number 612 to the number of the physical block 51 selected in S763 for the block mapping table 61 entry corresponding to the logical block for which this process was carried out (S766).

The function 76 repeats the above-mentioned S763 through S766 for all the logical blocks (S762).

According to the above-mentioned process, corresponding physical blocks 51 are allocated to all the logical blocks, and the block metadata 515 comprising the numbers of the logical blocks corresponding to these physical blocks 51 are stored in the allocated physical blocks 51. As a result, it becomes possible to suitably process an access from the host 11 thereafter. It also becomes possible to properly restore the logical/physical conversion information from the flash memory 4 when the power is turned ON.

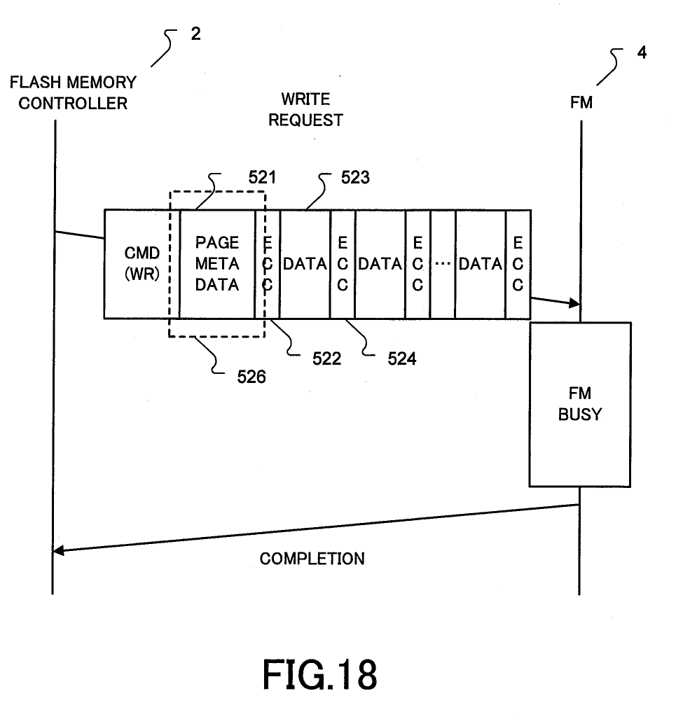

FIG. 18 shows an example of the exchange between the controller 2 and the chip array 4 in S726 of the host write service function 72.

The controller 2 sends the write command together with the data to be written to the physical page 52. The data to be written comprises the page metadata 526 and the ECC 522 thereof, and the data 523 sent from the host and the ECC 524 thereof.

Since the entire metadata write is carried out concomitantly with the write of the data sent from the host here, the metadata write does not substantially affect the write performance or number of writes-based service life of the flash memory.

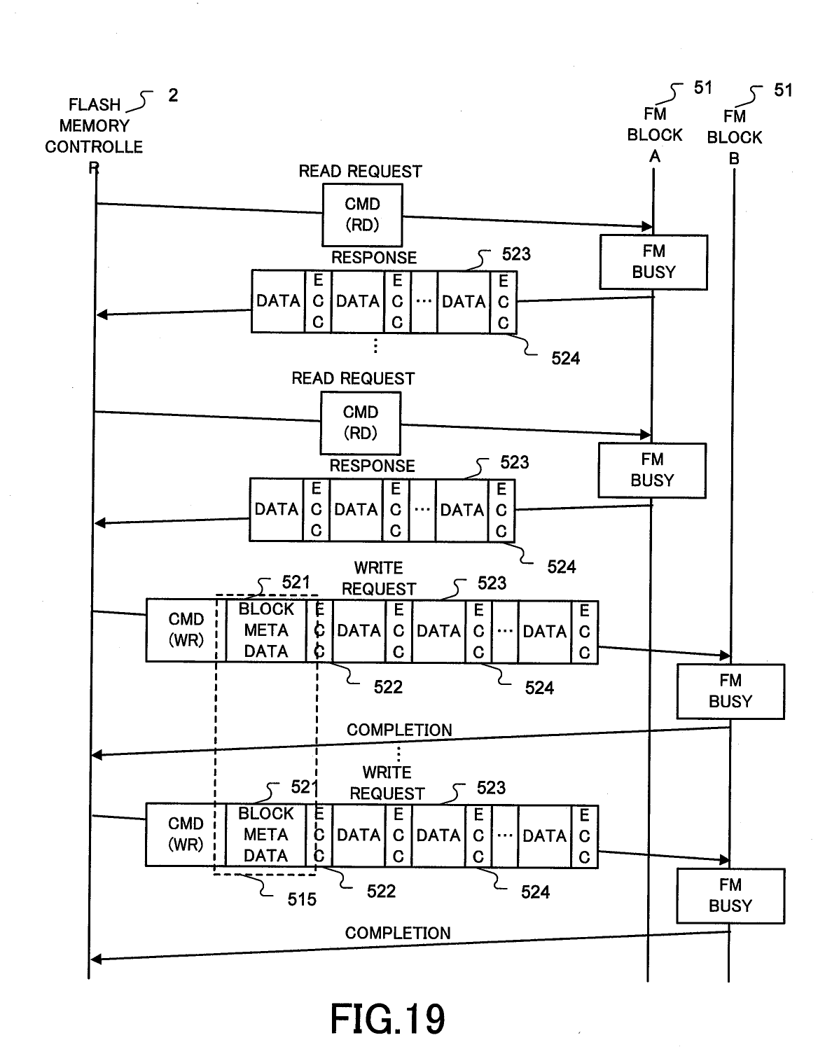

FIG. 19 shows an example of the exchanges between the controller 2 and the chip array 4 in S728 through S730 of the host write service function.

In this drawing, the physical block a is the old physical block, and the physical block b is the physical block that is to be used anew.

First, the latest data is read out from the physical page 6 in which the latest data inside the physical block a is stored. This corresponds to the operation carried out in S728.

Then, a write command for the physical page 52 inside the physical block b (the physical page 52 inside the master area) is sent together with the data to be written to this physical page 52. The data comprises a portion of the block metadata 515 and the ECC 522 thereof, and the data 523 sent from the host 11 and the ECC 524 thereof. This corresponds to S730.

Since the entire metadata write is carried out concomitantly with the write of the data sent from the host 11 here, the metadata write does not substantially affect the write performance or number of writes-based service life of the flash memory.

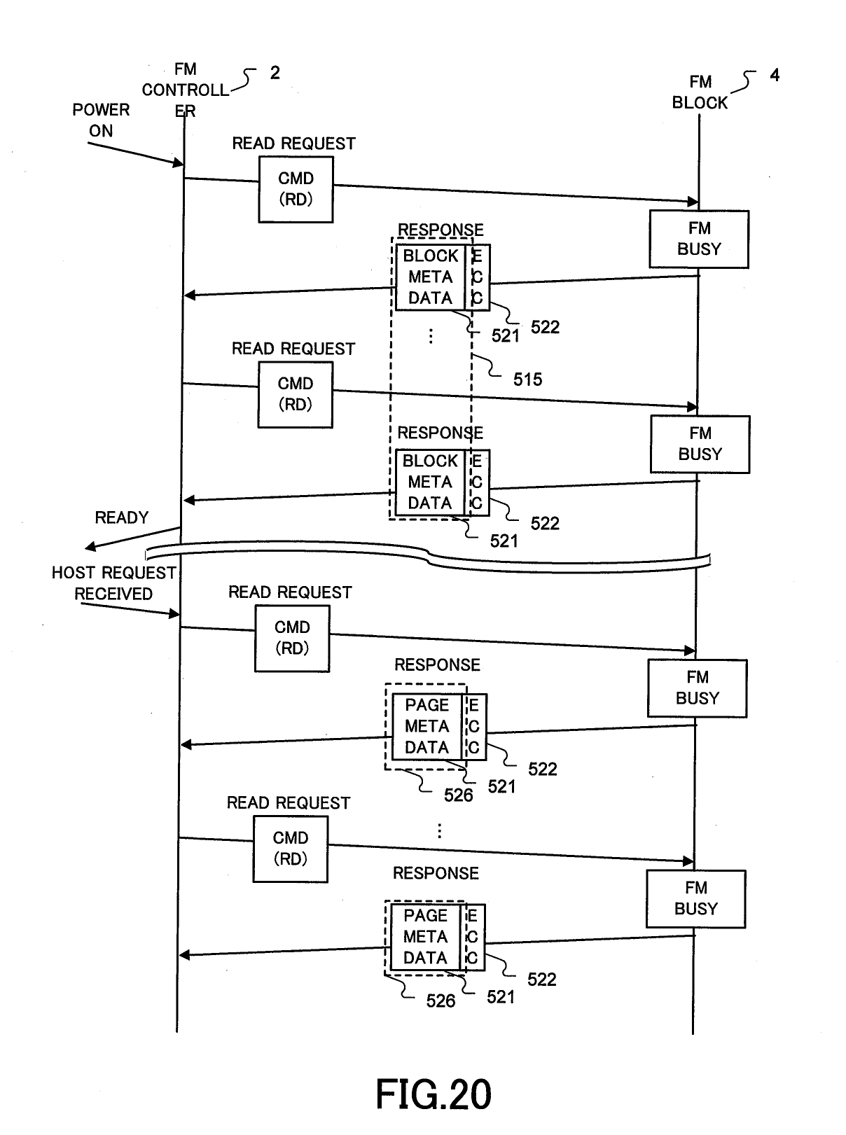

FIG. 20 shows an example of the exchanges between the controller 2 and the chip array 4 in S743 for the page mapping table reconstruct function 74 and S752 for the power ON function 75.

When the power is turned ON, first the block metadata 515 is read out from the physical block 51. Specifically, the metadata 521 and the ECC 522 thereof are read out from the physical pages 52 of the master area. This process is repeated for all of the physical blocks 52. The preceding corresponds to S752 of the power ON function 75. Then, when the read and construction are finished, the host 11 is notified to the effect that the flash memory module 1 is ready to receive I/O.

Thereafter, upon receiving an access request (I/O request) from the host 11, the page metadata 526 is read out from the specified physical block 51 on the basis of the logical address specified in this access request. Specifically, the metadata 521 and the ECC 522 thereof are read out from the physical page 52 inside the append area. This process is repeated for the physical pages 52 inside the append area. The preceding corresponds to S743 of the page mapping table reconstruct function 74.

Only the block metadata 515, that is, only the metadata 521 inside the master area is read out here when the power is turned ON; the page metadata 526 is not read out. For this reason, the time required for boot up is reduced, thereby making it possible to notify the host 11 to the effect that the flash memory module 1 is ready to receive I/O in a short period of time.

Also, in a case where an access request is received from the host 11, and a page mapping table 62 corresponding to the logical block specified on the basis of the logical address specified in this access request is not available, only the page metadata 526 is read out and the table 62 is created. For this reason, it is possible to restore the information for the logical/physical conversion using a minimal read.

According to the embodiment described above, it is possible to reduce the affects on the write performance of the flash memory during normal operation while cutting down on the time required for boot up.

One embodiment of the present invention has been explained above, but it goes without saying that the present invention is not limited to this embodiment, and that various changes are possible without departing from the gist thereof.

Furthermore, the page mapping table 62 may be prepared for each plurality of logical blocks instead of for each logical block. For example, when the controller 2 receives an access command, a page mapping table 62 corresponding to the access-destination logical block, which is specified on the basis of the logical address specified in this access command, and the next logical block may be created.

Also, a single master area and a single append area may be configured using two or more physical blocks. For example, a first physical block may be the master area, and a second physical block may be the append area.

The block mapping table 61 is constructed on the volatile memory 3, and a plurality of methods are conceivable as this construction method.

A first method stores a physical block number 612 in the volatile memory 3, and computes an address value on the volatile memory 3 in order to determine the physical block number 612 at access. This address value is determined from the logical block number 611 by adding a value obtained by multiplying the logical block number 611 by the number of bytes of configuration information in one entry of the block mapping table 61 to the start address value on the volatile memory 3 of the block mapping table 61. This address value is uniquely computed. In a case where either a read or write request is received from the host, it is possible to use this address value, access the volatile memory 3, and obtain the information of the physical block number 612 and the flag 613. This method is characterized in that it is possible to shorten the reference time.

A second method stores the information of the logical block number 611, the physical block number 612 and the flag 613 in the volatile memory 3 of the block mapping table 61 of the first method. This second method has the effect of enhancing reliability by making it possible to check that the address value computed from the logical block number 611 in the first method is correct by comparing this address value to the logical block number 611 stored in the volatile memory 3, and making it possible to detect a controller 2 logical error and a volatile memory 3 software error.

A third method stores the information of the logical block number 611, the physical block number 612 and the flag 613 in the volatile memory 3, and constructs a block mapping table 61 equivalent to the number of logical blocks being used. In a case where a logical block number 612 is not stored in a physical block, it is determined that the logical block is not being used. In this method, the effect is that the block mapping table 61 may be constructed on the capacity of the logical blocks being used, thereby making it possible to reduce the capacity of the block mapping table 61.

Also, as for S712 of FIG. 13, there are a plurality of methods for determining the physical block number 612 in accordance with the method for constructing the block mapping table 61. For example, there is a method for determining an address in the block mapping table 61 and finding the physical block number 612 that is stored there by carrying out a computation based on the read-source logical block number 611. In addition, there is also a method for storing the value of the read-source logical block number 611 in the block mapping table 61 as well, and checking to make sure that the computation is correct. Further, there is a method for storing a pair of the values of the read-source logical block number 611 and the physical block number 612 in the block mapping table 61, and using the read-source logical block number 611 to search inside the block mapping table 61 to find the corresponding physical block number 612.

Also, as for S722 of FIG. 14, there are a plurality of methods for determining the physical block number 612 in accordance with the method for constructing the block mapping table 61. There is a method for determining the address in the block mapping table 61 and finding the physical block number that is stored there by carrying out a computation based on the write-destination logical block number, there is also a method for storing the value of the write-destination logical block number in the block mapping table 61 as well, and checking to make sure that the computation is correct, and furthermore, there is a method for storing a pair of the values of the write-destination logical block number and the physical block number in the block mapping table 61, and using the write-destination logical block number to search inside the block mapping table 61 to find the corresponding physical block number.

When constructing the block mapping table 61 in S754 of FIG. 16, there are a plurality of methods for writing data into the block mapping table 61 in accordance with the method for constructing the block mapping table 61.

A first method determines an address in the block mapping table 61 by carrying out a computation based on a logical block number 517 selected from the metadata 515 and stores the physical block number 611 at this address.

A second method, in addition to the processing in the first method, also stores the logical block number 517 in the block mapping table 61 for checking the computed address.

A third method stores a pair comprising the logical block number 517 and the physical block number 611 in the order of the physical blocks 51 from which the block metadata 515 has been read out. In a case where a logical block number 517 is not stored in the physical block 51, that is, a case in which the physical block 51 is not being used, neither the logical block number 517 nor the physical block number 611 is stored in the block mapping table 61.

### REFERENCE SIGNS LIST

1 Flash memory module

1. A flash memory module, comprising:
a flash memory; and
a controller receiving an access command from a host, and, based on logical/physical conversion information denoting a corresponding relationship between a logical address and a physical address of the flash memory, accessing an area in accordance with a physical address corresponding to a logical address specified in the received access command,
wherein the logical/physical conversion information comprises first conversion information and second conversion information, and
wherein the controller restores the first conversion information at boot up time, enables an access command to be received after the first conversion information has been restored, and restores the second conversion information after an access command is able to be received.

2. A flash memory module according to claim 1,
wherein the flash memory is a flash memory in which an access is carried out in page units and an erase is carried out in block units,
wherein the flash memory comprises a plurality of physical blocks,
wherein each physical block comprises a plurality of physical pages,
wherein the first conversion information is block mapping information denoting a corresponding relationship between logical blocks and physical blocks,
wherein the second conversion information is page mapping information denoting a corresponding relationship between logical pages and physical pages,
wherein the page mapping information is information restored for each of one or more physical blocks,
in a case where user data is to be written for the first time to an empty physical block, which is a physical block in an erased state, wherein the controller writes a block metadata, which is data comprising an ID of the logical block to which this empty physical block is allocated, to this empty physical block in addition to the user data,
in a case where a certain user data inside the physical block is to be updated, wherein the controller writes, in addition to a post-update user data, a page metadata, which is data comprising an ID of a write-destination logical page of the post-update user data, to a physical page other than the physical page in which the certain user data is stored,
wherein the controller restores the block mapping information at the boot up time by reading in the block metadata from each physical block of the flash memory, and
wherein the controller:
(W) in a case where a write command is received from the host after an access command is able to be received;
(w1) specifies a write-destination logical block and a write-destination logical page based on a logical address specified in the received write command;
(w2) specifies a physical block corresponding to the write-destination logical block based on the block mapping information;
(w3) determines whether or not valid page mapping information corresponding to the write-destination logical block is available;
(w4) in a case where the result of the determination of the (w3) is negative, creates the page mapping information corresponding to the write-destination logical block by reading in the page metadata from the physical page inside the physical block corresponding to the write-destination logical block;
(w5) stores a target user data of the received write command and the page metadata comprising an ID of the write-destination logical page either in the physical page inside the physical block corresponding to the write-destination logical block, or the physical page inside another physical block associated with the write-destination logical block, and updates the page mapping information corresponding to the write-destination logical block, and
(R) in a case where a read command is received from the host after an access command is able to be received;
(r1) specifies a read-source logical block and a read-source logical page based on a logical address specified in the received read command;
(r2) specifies a physical block corresponding to the read-source logical block based on the block mapping information;
(r3) determines whether or not a valid page mapping table corresponding to the read-source logical block is available;
(r4) in a case where the result of the determination of the (r3) is negative, creates the page mapping information corresponding to the read-source logical block by reading in the page metadata from the physical page inside the physical block corresponding to the read-source logical block; and
(r5) specifies the physical page corresponding to the write-destination logical page based on the page mapping information corresponding to the write-destination logical block, and reads out the user data from the specified physical page.

3. A flash memory module according to claim 2,
wherein when storing the block metadata, the controller stores a part of the block metadata that is stored in the physical page together with an ECC (Error Correcting Code),
wherein when storing the page metadata, the controller also stores the ECC in addition to the page metadata,
wherein when reading in the block metadata, the controller determines the presence or absence of an error in each part by using the ECC read in together with the each part of the block metadata, and
wherein when reading in the page metadata, the controller determines the presence or absence of an error in this page metadata by using the ECC read in together with this page metadata.

4. A flash memory module according to claim 2,
wherein a master area and an append area are configured from in or more physical blocks, and
wherein the block metadata is stored in the master area, and the page metadata is stored in the append area.

5. A flash memory module according to claim 4, wherein the controller, for each logical page, writes a user data, which is not the post-update user data, to the physical page belonging to the master area, and writes the post-update user data and the page metadata comprising an ID of the write-destination logical page of this post-update user data to the physical page belonging to the append area.

6. A flash memory module according to claim 1,
wherein the flash memory is a flash memory in which an access is carried out in area units and an erase is carried out in area group units comprising a plurality of areas,
wherein the first conversion information is information denoting a corresponding relationship between logical areas and physical areas, and
wherein the second conversion information is information denoting a corresponding relationship between logical area groups and physical area groups.

7. A flash memory module according to claim 6, wherein the second conversion information is information restored for each of one or more area groups.

8. A flash memory module according to claim 7,
wherein the area group is a block, and
wherein the controller receives an access command from the host, and in a case where the valid second conversion information is not available for the block specified based on the logical address specified in this access command, restores the second conversion information for one or more blocks comprising this block.

9. A flash memory module according to claim 8,
wherein a master area and an append area are configured in one or more physical blocks, and
wherein the controller:
(X) when writing the user data to the append area, also writes information required to restore the second conversion information to the append area; and
(Y) when writing the user data to the master area, also writes information required to restore the first conversion information to the master area.

10. A flash memory module according to claim 7,
wherein the controller stores, in respective one or more physical area groups, first management information comprising information denoting one or more logical area groups to which the one or more physical area groups are allocated,
wherein the controller stores, in a physical area in the physical area group, second management information comprising information denoting a logical area allocated to this physical area,
wherein the controller restores the first conversion information by reading in the first management information from the respective one or more physical area groups, and
wherein the controller restores, for one or more logical area groups, the second conversion information corresponding to the one or more logical area groups by reading in the second management information from each physical area in which the second management information is stored.

11. A flash memory module according to claim 10,
wherein when storing the first management information, the controller stores a part of the first management information that is stored in the physical area together with an ECC (Error Correcting Code),
wherein when storing the second management information, the controller also stores the ECC in addition to the second management information,
wherein when reading in the first management information, the controller determines the presence or absence of an error in each part by using the ECC read in together with the each part of the first management information, and
wherein when reading in the second management information, the controller determines the presence or absence of an error in this second management information by using the ECC read in together with this second management information.

12. A flash memory module according to claim 1, wherein the controller restores the second conversion information in a case where the controller receives an access command from the host.

13. A flash memory module according to claim 1, wherein the flash memory is configured from one or more physical blocks, the controller is connected to a memory, and the controller reads out a logical address from the physical block at boot up time, and stores the logical address and a physical address that corresponds to this logical address in the memory as the first conversion information.

14. A flash memory module according to claim 13, wherein the controller reads out the logical address from the physical block at boot up time, and calculates a first address value corresponding to the logical address storage location from the logical address and a start address value of the memory,
the controller calculates a second address value from the start address value and the logical block address stored in the memory, and
the controller confirms that the first address value and the second address value match.

15. A control method of a flash memory module receiving an access command from a host, and, based on logical/physical conversion information denoting a corresponding relationship between a logical address and a physical address of a flash memory, accessing an area in accordance with a physical address corresponding to a logical address specified in the received access command, the method comprising the steps of:
restoring first conversion information of the logical/physical conversion information at boot up;
notifying the host that an access command is able to be received after having restored the first conversion information; and
restoring second conversion information of the logical/physical conversion information after having notified the host that an access command is able to be received.
